(19) United States
(12) Patent Application Publication
(10) Pub. No.: US 2021/0310754 A1
(43) Pub. Date: Oct. 7, 2021

(54) ALUMINIUM ALLOY FIN STOCK MATERIAL

(71) Applicant: Aleris Rolled Products Germany GmbH, Koblenz (DE)

(72) Inventors: David Ian WARBY, Reading (GB); Henricus Matheus VAN DER DONK, Velserbroek (NL); Bernd JACOBY, Limburgde (DE); Achim BÜRGER, Hohr-Grenzhausen (DE); Steven KIRKHAM, Ransbach-Baumbach (DE)

(21) Appl. No.: 17/250,786

(22) PCT Filed: Sep. 5, 2019
(86) PCT No.: PCT/EP2019/073661

§ 371 Date: Mar. 3, 2021

(30) Foreign Application Priority Data
Sep. 24, 2018 (EP) 18196278.8

(51) Int. Cl. F28F 21/08; C22F 1/053; C22C 21/10; F28F 1/12

(52) U.S. Cl. CPC F28F 21/084; C22F 1/053; B23K 1/0012; F28F 1/126; F28F 21/089; C22C 21/10

(57) ABSTRACT

The invention relates to a rolled fin stock material from an 3xxx-series aluminium alloy comprising, in wt. %, Mn 0.7% to 2.0%, Si 0.4% to 1.5%, Zn up to 4%, Fe up to 0.8%, Zr 0.02% to 0.40%, Sc 0.01% to 0.6%, Ni up to 0.3%, Cu up to 0.5%, Mg up to 2%, Cr up to 0.3%, Ti up to 0.3%, the balance aluminium and tolerable impurities. The invention further relates to a brazed assembly of components incorporating such a fin stock material.

### FIELD OF THE INVENTION

The invention relates to a rolled fin stock material from a 3xxx-series aluminium alloy comprising at least 0.7% to 2.0% Mn. The invention further relates to a brazed assembly of components incorporating such a fin stock material.

### BACKGROUND TO THE INVENTION

As will be appreciated herein below, except as otherwise indicated, aluminium alloy designations and temper designations refer to the Aluminium Association designations in Aluminium Standards and Data and the Registration Records, as published by the Aluminium Association in 2018 and are well known to the person skilled in the art.

For any description of alloy compositions or preferred alloy compositions, all references to percentages are by weight percent unless otherwise indicated.

The term “up to” and “up to about”, as employed herein, explicitly includes, but is not limited to, the possibility of zero weight-percent of the particular alloying element to which it refers. For example, up to about 0.3% Ni may include an alloy having no Ni.

Heat exchangers and other similar equipment, such as condensers, evaporators and the like for use in car coolers, air conditioning systems, industrial cooling systems, etc. usually comprise a number of heat exchange tubes arranged in parallel between two headers, each tube joined at either end to one of the headers. Corrugated fins are disposed in an airflow clearance between adjacent heat exchange tubes and are brazed to the respective tubes.

The fin material or fin stock material for brazed heat exchangers is typically fabricated from 3xxx-series aluminium alloys such as, for example AA3003 or AA3003 with a purposive addition of Zn up to about 3%.

The fin stock material is joined to the heat exchange tubes in a brazing operation employing an aluminium alloy brazing filler, most commonly made from an AA4xxx-series alloy. The brazing filler is typically present on the outer surface of the heat exchange tube, but also the use of a clad fin configuration alone is being employed.

The most used brazing processes used on an industrial scale are vacuum brazing and controlled atmosphere brazing using a salt-based brazing flux material. A more recent development concerns controlled atmosphere brazing without the use of salt-based brazing flux material.

U.S. Pat. No. 9,493,861-B1 discloses a method for producing AlMn strip or sheet for making components by brazing, in particular to fin materials used in heat exchangers. The resultant fin material is said to have an increased sagging resistance. The aluminium alloy comprises, in wt. %: 0.3-1.5% Si, <0.5% Fe, <0.3% Cu, 1.0-2.0% Mn, <0.5% Mg, <4.0% Zn, 0.3% each of dispersoid forming elements from the group IVb, Vb, or VIb, and unavoidable impurities, balance aluminium.

U.S. Pat. No. 9,714,799 discloses a method for producing AlMn strip or sheet for making components by brazing, in particular to fin materials used in heat exchangers. The resultant fin material is said to have an ultra-sagging resistance. The aluminium alloy comprises, in wt. %: <0.30% Si, <0.5% Fe, <0.3% Cu, 1.0-2.0% Mn, <0.5% Mg, <4.0% Zn, 0.3% each of dispersoid forming elements from the group IVb, Vb, or VIb, and unavoidable impurities, balance aluminium.

CN-103060622-A discloses a method for producing fins for an automotive heat exchanger by continuous roll casting of an Al—Mn—Zn—Sc aluminium alloy, the aluminium alloy having 0.05-0.15% Sc, 0.44-0.58% Si, 0.45-0.55% Fe, 0.10-0.15% Cu, 1.05-1.25% Mn, <0.05% Mg, 1.40-1.60% Zn, <0.025% Cr, <0.045% Ni, <0.045% Ti, <0.045% Zr, and the balance aluminium.

JP-2006-176852-A discloses a brazing sheet product having a core alloy clad on one side with an Al—Si or Al—Si—Zn based brazing alloy and on the other side an aluminium alloy sacrificial anode layer. The aluminium alloy sacrificial anode layer contains 0.0001-1.0% Sc and 0.2-0.8% Zn, and one or more elements selected from the group of 0.005-3.0% Mn, 0.05-2.5% Fe, 0.05-1.5% Si, <0.1% Cu, 0.01-2.0% Mg and 0.001-0.3% Zr, and the balance aluminium and inevitable impurities. The brazing sheet product can be used for tubes or fins in a heat exchanger.

JP-2006-176850-A discloses an aluminium alloy fin material for a heat exchanger, and comprising 0.0001-1.0% Sc, 0.005-3.0% Mn and 0.01-8.0% Zn, and further one or more elements selected from 0.05-2.5% Fe, 0.05-1.5% Si, 0.05-0.8% Cu, 0.01-0.5% Mg and 0.001-0.3% Zr, and the balance aluminium and inevitable impurities.

WO-2016/190409-A1 discloses a high-strength 6XXX-series aluminium alloy automotive sheet for panel components and automobile structural components, the aluminium alloy comprising, 0.3-1.5% Mg, 0.3-1.5% Si, and at least one transition element selected from the group consisting of 0.1-0.8% Mn, 0.04-0.20% Zr, 0.04-0.20% Cr, and 0.02-0.1% Sc, balance aluminium and unavoidable impurities, and wherein the sheet at mid-thickness has an average grain size of 100 micron or less, and dispersoid particles comprising the at least one transition element of a defined average equivalent circle diameter and density.

There is room for improvement in the art of aluminium alloy fin stock material for use in brazed heat exchangers and having a further improved sagging resistance.

### DESCRIPTION OF THE INVENTION

It is an object of the invention to provide a rolled aluminium alloy fin stock material for brazed heat exchangers having at least an improved sagging resistance.

This and other objects and further advantages are met or exceeded by the present invention and providing a rolled fin stock material from an 3xxx-series aluminium alloy comprising, in wt. %,

| | |
|---|---|
| Mn | 0.7% to 2.0%, |
| Si | 0.4% to 1.5%, |
| Zn | up to 4%, preferably 0.35% to 3%, |
| Fe | up to 0.8%, |
| Zr | 0.02% to 0.40%, |
| Sc | 0.01% to 0.6%, |
| Ni | up to 0.3%, |
| Cu | up to 0.5%, |
| Mg | up to 2%, |
| Cr | up to 0.3%, |
| Ti | up to 0.3%, |

the balance aluminium and tolerable impurities.

In accordance with the present invention it has been found that the rolled fin stock material has a high post-braze strength combined with excellent brazing performance in terms of a high sagging resistance and a very low susceptibility to liquid core penetration during brazing, as well as good forming properties in the as-delivered condition. In particular the sagging resistance at elevated temperature has been significantly improved due to the combined addition of Sc and Zr to the aluminium alloy

The rolled fin stock material is mainly intended for thin fin applications in heat exchangers produced by CAB brazing but can also be produced by vacuum brazing.

Mn is the most important alloying element in the fin stock material and contributes to both particle and solid solution strengthening. Furthermore, Mn in a controlled number of particles is beneficial to control the sagging resistance and sensitivity to liquid core penetration as these particles control the recrystallisation process during braze heating leading to the formation of large recrystallised grains. The Mn content should be in the range of about 0.7% to 2.0%. A preferred lower limit for the Mn content is about 1.0%, and more preferably about 1.3%. A more preferred upper limit for the Mn content is about 1.85%.

Si contributes combined with Mn to both particle and solid solution strengthening. This promotes high post-braze strength and sagging resistance. An insufficient Si content, for example of less than about 0.4%, results in reduced strengthening while too much Si, for example more than about 1.5%, results in decreased thermal conductivity and a reduced melting temperature undesirably affecting the heat exchanger during the brazing operations. A preferred lower limit for the Si content is about 0.5%, and more preferably about 0.65%. The upper limit for the Si content is 1.5%, preferably about 1.2%, and most preferably about 1.1%.

Fe is present in all known commercially available aluminium alloys. With a too high Fe content among other things the formability of the material decreases and also the corrosion performance is decreasing. The preferred admissible Fe content is up to about 0.8% maximum, and more preferably up to about 0.6% maximum. A practical Fe content is in the range of about 0.15% to 0.45% and allows for a good compromise in desired properties of the fin stock material such as post-braze strength and sagging resistance, while the fin stock material can be manufactured without great difficulties at least in part from scrap materials.

The fin stock material may have relatively high levels of Mn, Si and Fe without departing from the concept of the present invention. In particular when high solidification rates during casting, typically as obtained by continuous casting such as twinroll casting, are applied in the manufacturing process of producing the fin stock material the relatively high levels of alloying elements can be employed resulting in an alloy strip substantially without coarse intermetallics. When applying continuous casting techniques to produce feedstock for the fin stock material clearly also the lower and middle end of the disclosed ranges can be applied. In casting processes like direct chill (DC) casting of slabs or billets the solidification rates are such that in industrial practice the Fe level commonly does not exceed 0.6%, the Mn level does not exceed 1.85%, and the Si level does not 1.2%, otherwise detrimental coarse intermetallics can be produced, such as for example, primary Fe-bearing intermetallics. The exact Si, Fe and Mn-contents are tuned based on the formability, strength, corrosion resistance and sag resistance requirements of the specific application.

Together with the Mn and Si, the purposive addition of scandium (Sc) in combination with the Zr is an essential alloying element and the Sc should be present in a range of about 0.01% to 0.6% to arrive at improved sagging resistance at elevated temperatures. Also the strength properties in the post-braze condition at elevated temperatures are increased. A preferred lower limit for the Sc is 0.05%, and more preferably 0.12%, and more preferably 0.17%. A more preferred upper-limit is 0.4%, and more preferably 0.30%.

The aluminium alloy should contain also at least Zr in a range of 0.02% to 0.40%. In an embodiment the upper-limit for the Zr-content is 0.30%, and more preferably 0.2%. A preferred lower-limit for the Zr-content is 0.06%, and more preferably 0.08%.

Zr combines with Sc to form a dispersoid having a reduced lattice mismatch between the dispersoid and aluminium matrix, which results in an enhanced inhibition of recrystallisation and thus leading to a higher recrystallisation temperature. The combined Sc and Zr addition favours the formation of larger post-braze grains after recrystallisation during the brazing heat-up and thereby increasing the sagging resistance. The increase is significantly higher compared to the addition of solely Sc or solely Zr in a similar compositional range. In the aluminium alloy according to the invention there must be a combined addition of at least Sc and Zr in order to achieve the desired post-braze strength properties. In an embodiment the combined addition of Sc and Zr is at least 0.20%, and preferably at least 0.23%. In the better examples the combined addition of Sc and Zr is at least 0.25%.

The addition of Mg increases the post-braze strength of the fin stock alloy significantly, but at too high levels it may increase the risk of incipient melting of phases in the fin stock material during the brazing operation. For controlled atmosphere brazing (CAB) higher Mg contents are not desired because of a potential poisoning effect on the brazing flux material. When employed in a vacuum brazing operation the Mg content in the fin stock alloy is much less critical and can be present up to about 2%. The Mg content can be present up to 2%, preferably up to 0.5%, preferably up to 0.35%, and most preferably up to 0.10%.

Cu can enhance the post-braze strength of the fin stock material, however, it can have a detrimental influence on the corrosion potential of the fin material. Cu may be tolerated up to about 0.5%, this achieves advantages in the tolerance of this fin stock alloy for impurity elements and allows this alloy to be composed from large amounts of scrap material, such as discarded heat exchangers, but not limited to this example. A more preferred range for the Cu-level is up to about 0.30%, and more preferably up to about 0.20%, as a compromise in achieving post-braze strength, corrosion resistance and brazeability. If the corrosion resistance prevails as very important property for the use of the fin stock material in a certain heat exchanger application, then the Cu content is preferably kept at levels below 0.20%, and most preferably below 0.05%, for example at a level of not more than 0.01% or 0.02%.

The alloying element zinc (Zn) affects the corrosion potential of the fin stock material and can be present up to about 4%. By reducing the corrosion potential of the fin stock, Zn has the effect of causing the fins to function as sacrificial anodes, thereby providing corrosion protection for the tubes of the heat exchanger to which they are brazed. Zinc has a detectable, but relatively small effect on the strength and thermal conductivity. For this reason, a minimum amount of Zn required for cathodic protection of the tube is added; usually that will require at least 0.35% Zn, and more preferably at least 0.5%. More than about 4% Zn will have an impact on the self-corrosion rate. However, in some instances, such higher Zn contents of up to about 3% Zn might be desirable at the expense of thermal conductivity and self-corrosion properties. By using an adjustable Zn content in the fin, the difference in corrosion potential between tubes and fins can be chosen to an adequate level for each application. A preferred upper limit for the Zn content is 2.7%. In a particular embodiment, the upper limit for the Zn content is about 1.9%.

Ni has been shown to promote strength without a significant detrimental influence on thermal conductivity. It is known, however, to have a negative impact on the self-corrosion characteristics of the fin stock material. It is envisioned that up to about 0.3% might be tolerated in some specific instances, however, in general, Ni should be kept to less than about 0.05%, and preferably less than 0.03%.

Cr can be added up to about 0.3% as another dispersoid forming element.

Ti may be present up to about 0.3% to act in particular as a grain refining additive during the casting of an ingot of the fin stock material of the invention. Additional Ti may be added, for example due to their presence in scrap material, to increase the strength of the fin alloy by solubility hardening. The total amount of Ti present in the aluminium alloy should preferably not exceed about 0.20%, but preferably is less than 0.10%.

The balance is made by aluminium and incidental impurities and tolerable impurities, typically each up to 0.05% maximum and in total about 0.25% maximum, and preferably in total not exceeding 0.15%.

In a particular embodiment of the aluminium fin stock material it concerns a composition consisting of, in wt. %: Mn 0.7-2.0%, Si 0.4-1.5%, Zn up to 4%, Fe up to 0.8%, Zr 0.02-0.40%, Sc 0.01-0.6%, Ni up to 0.3%, Cu up to 0.5%, Mg up 2%, Cr up to 0.3%, Ti up to 0.3%, the balance aluminium and impurities each <0.05%, total <0.25%, and with preferred narrower compositional ranges as herein described and claimed.

The rolled fin stock material can be manufactured using method of producing fin stock material known in the art, for example those disclosed is U.S. Pat. No. 9,493,861-131 and 9,714,799-B2.

For the casting of the rolling feedstock a continuous casting technique, e.g. twin-belt casting or roll casting, is favoured over a direct chill (DC) type casting technique. The relative high cooling rate during a continuous casting operation provides a more favourable and fine distribution of dispersoid particles and other microstructural features resulting in the high required post-braze strength combined with an increased sagging resistance, in particular at elevated temperatures.

In view of the presence for the Sc and Zr as alloying elements, to produce the optimum performance of the aluminium alloy as fin stock material, the homogenisation temperature and/or the pre-heat temperature prior to hot rolling is preferably in the range of about 300° C. to 500° C., and more preferably in the range of about 370° C. to 480° C., to control the formation of small dispersoid particles. The soaking time is typically in a range of about 1 to 50 hours.

Following the homogenisation and/or pre-heat step, a hot rolling step can be performed. The hot-mill entry temperature is preferably in a range of about 350° C. and 470° C. The aluminium alloy can be hot rolled to a gauge typically of about 2 mm to 15 mm, and subsequently cold rolled to final gauge. Optionally, the rolled aluminium sheet can be annealed by heating the sheet from room temperature to an annealing temperature regular in the art to arrive at the required temper.

In an embodiment the rolled fin stock material is provided with an aluminium alloy clad layer on one or both sides, using cladding layer thicknesses of 3% to 20%, preferably 3% to 15%, of the total thickness of the strip on each side. The aluminium alloy clad layer may be a 4xxx-series filler alloy typically having Si in a range of 5% to 14% as its main alloying constituent. Typical filler alloys within this series are AA4343, AA4045, AA4047, AA4004, AA4104, AA4047 and AA4147, or some near compositional variants thereof, or 4xxx alloys having a purposive addition of Zn up to about 5%, as well as typical protective based on commercially pure aluminium alloys (e.g. AA1xxx-series). The aluminium alloy clad layer(s) is preferably applied by roll bonding as in well known in the art.

In an embodiment the rolled fin stock material is provided in a bare form, thus devoid of any metallic layers, such as for example a 4xxx-series brazing clad layer, on its outer surface.

At final gauge the rolled fin stock material is typically at a gauge in the range of about 0.02 mm to 1.0 mm, preferably from about 0.02 mm to 0.3 mm. A preferred lower-limit for the gauge is about 0.03 mm. A preferred upper-limit for the gauge is about 0.2 mm, more preferably 0.15 mm, and most preferably 0.10 mm.

In the pre-braze condition the rolled fin stock material is typically provided in an H1x or H2x temper, wherein x has a value from 1 to 9, such as for example the H14, H18, H22, H24 and H26 temper.

In an aspect of the invention there is provided in a brazed assembly, typically a heat exchanger, comprising the rolled fin stock material of the invention. In such a heat exchanger having the rolled fin stock material of the invention as corrugated fins, the fins may act as a sacrificial anode. The brazed heat exchanger typically comprises at least one tank structured to hold a coolant; a header plate coupled to said at least one tank, said header plate including a plurality of apertures; a plurality of substantially parallel fluid-carrying tubes each extending substantially perpendicular from one of said plurality of apertures in said header plate and structured to receive said coolant therethrough; and a plurality of fins, said fins being in thermal communication with said plurality of fluid-carrying tubes and structured to transfer heat away therefrom, in order to cool said coolant as it circulates therein, said plurality of fins being made from the rolled fin stock material as herein disclosed and claimed.

The heat exchangers incorporating the rolled stock material according to this invention can be used widely in the transportation industries, such as the automotive industry, for powertrain cooling and HVAC&R applications, as well as for domestic and industrial cooling purposes, e.g. for fluid processing and HVAC&R applications.

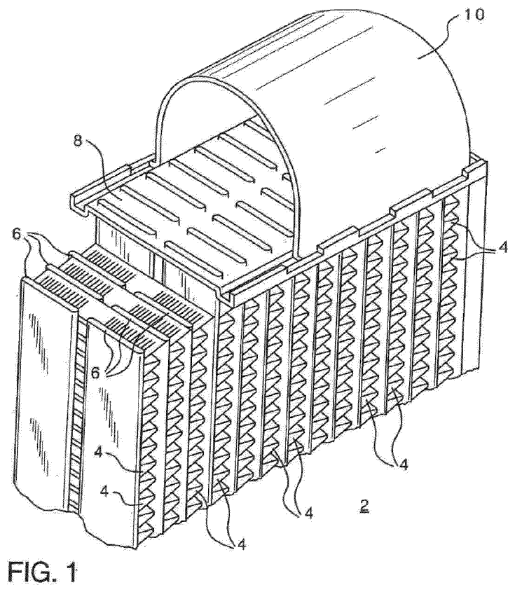

FIG. 1 is an isometric view of a portion of a brazed heat exchanger.

As shown in FIG. 1, a brazed aluminium heat exchanger 2 in accordance with the present invention includes a plurality of fluid-carrying tubes 6. The ends of the fluid-carrying tubes 6 are open to a header plate 8 and a tank 10 (one end of the fluid-carrying tubes 6, one header plate 8 and one tank 10 are shown in FIG. 1). Coolant is circulated from the tank 10, through the fluid-carrying tubes 6 and into another tank (not shown). As shown, a plurality of cooling fins 4, made from the rolled fin stock material according to this invention, are disposed between the fluid-carrying tubes 6, in order to transfer heat away therefrom thereby facilitating a heat exchange cooling the fluid therein.

While various embodiments of the technology described herein have been described in detail, it is apparent that modifications and adaptations of those embodiments will occur to those skilled in the art. However, it is to be expressly understood that such modifications and adaptations are within the spirit and scope of the presently disclosed technology.

1. A rolled fin stock material from an 3xxx-series aluminium alloy comprising, in wt. %,

| | |
|---|---|
| Mn | 0.7% to 2.0%, |
| Si | 0.4% to 1.5%, |
| Zn | up to 4%, |
| Fe | up to 0.8%, |
| Zr | 0.02% to 0.40%, |
| Sc | 0.01% to 0.6%, |
| Ni | up to 0.3%, |
| Cu | up to 0.5%, |
| Mg | up to 2%, |
| Cr | up to 0.3%, |
| Ti | up to 0.3%, |

the balance aluminium and tolerable impurities.

2. The rolled fin stock material according to claim 1, wherein the Sc content is at least 0.05%.

3. The rolled fin stock material according to claim 1, wherein the Sc content is maximum 0.4%.

4. The rolled fin stock material according to claim 1, wherein the Zr content is at least 0.06%.

5. The rolled fin stock material according to claim 1, to wherein the Zr content is maximum 0.30%.

6. The rolled fin stock material according to claim 1, wherein the Mn content is at least 1.0%.

7. The rolled fin stock material according to claim 1, wherein the Mn content is at most 1.85%.

8. The rolled fin stock material according to claim 1, wherein the Cu content is maximum 0.30%.

9. The rolled fin stock material according to claim 1, wherein the Mg content is maximum 0.5%.

10. The rolled fin stock material according to claim 1, wherein the Zn content is at least 0.35%.

11. The rolled fin stock material according to claim 1, wherein a clad layer is applied on one or both sides of the rolled fin stock material.

12. The rolled fin stock material according to claim 1, wherein the rolled fin stock material is devoid of any metallic layer(s) applied on either side.

13. The rolled fin stock material according to claim 1, wherein the rolled fin stock material at final gauge has a thickness of 0.02 mm to 0.3 mm.

14. The rolled fin stock material according to claim 1, wherein the rolled fin stock material in the pre-braze condition is provided in an H1x or H2x temper and wherein x is from 1 to 9.

15. The rolled fin stock material according to claim 1, wherein the rolled fin stock material has been produced by a continuous casting operation.

16. A method of manufacturing a rolled fin stock material according to claim 1, comprising the steps of casting rolling feedstock, homogenising and/or pre-heating of the rolling feedstock at a temperature in a range of 300° C. to 500° C. prior to hot rolling to a gauge of 2 mm to 15 mm, cold rolling to final gauge, and optionally annealing of the cold rolled material at final gauge.

17. A brazed assembly of components, comprising a plurality of substantially parallel fluid-carrying tubes and a plurality of fins, said plurality of fins being in thermal communication with said plurality of fluid-carrying tubes and structured to transfer heat away therefrom, and said plurality of fins comprising a rolled fin stock material according to claim 1.

18. The brazed assembly of components according to claim 17, wherein the brazed assembly of components is a heat exchanger.
